(19) United States
(12) Patent Application Publication
(10) Pub. No.: US 2024/0329905 A1
(43) Pub. Date: Oct. 3, 2024

(54) DATA OUTPUT APPARATUS AND SYSTEM THEREOF

(71) Applicant: Lenovo (Beijing) Limited, Beijing (CN)

(72) Inventors: Junpeng HAO, Beijing (CN); Tien-Fang YU, Beijing (CN)

(21) Appl. No.: 18/606,735

(22) Filed: Mar. 15, 2024

(30) Foreign Application Priority Data
Mar. 31, 2023 (CN) 202310344201.2

(51) Int. Cl. G06F 3/14; G09G 3/32

(52) U.S. Cl. CPC G06F 3/14; G09G 3/32

(57) ABSTRACT

A data output apparatus includes a first connection device configured to be detachably connected to a second connection device of a processing apparatus to maintain a positional relationship between the data output apparatus and the processing apparatus, a communication device configured to receive display data sent by the processing apparatus, and a display device configured to output the display data and including a first display assembly and a second display assembly.

### CROSS-REFERENCE TO RELATED APPLICATION

This application claims priority to Chinese Patent Application No. 202310344201.2, filed on Mar. 31, 2023, the entire content of which is incorporated herein by reference.

### TECHNICAL FIELD

The present disclosure generally relates to the field of display technologies and, more particularly, to a data output apparatus and a data output system.

### BACKGROUND

In practical applications, display data processed by a processing apparatus can be output through a display device associated with it. The display device includes a display screen with a communication connection established to the processing apparatus, etc. However, the setting method of the above-mentioned display screen is unitary and hence the above-mentioned display data cannot be displayed with flexibility and diversity.

### SUMMARY

In accordance with the present disclosure, there is provided a data output apparatus including a first connection device configured to be detachably connected to a second connection device of a processing apparatus to maintain a positional relationship between the data output apparatus and the processing apparatus, a communication device configured to receive display data sent by the processing apparatus, and a display device configured to output the display data and including a first display assembly and a second display assembly.

Also in accordance with the present disclosure, there is provided a data output system including a data output apparatus including a first connection device, a first communication device, and a display device including a first display assembly and a second display assembly, and a processing apparatus including a second connection device, a second communication device, and a processing device. The first connection device and the second connection device are configured to be detachably connected to each other to maintain a positional relationship between the data output apparatus and the processing apparatus. The processing device is configured to generate display data. The second communication device is configured to transmit the display data to the first communication device. The first communication device is configured to receive display data. The display device is configured to output the display data.

### BRIEF DESCRIPTION OF THE DRAWINGS

FIG. 1 is a schematic structural diagram showing a data output apparatus consistent with the present disclosure.

FIG. 2 is a schematic structural diagram showing a data output system consistent with the present disclosure.

FIG. 3 is a schematic structural diagram showing another data output system consistent with the present disclosure.

FIG. 4 is a schematic diagram showing directions when a display area of a first display assembly faces a display area of a second display assembly and a first connection device is connected to a second connection device, consistent with the present disclosure.

FIG. 5 is another schematic diagram showing directions when a display area of a first display assembly faces a display area of a second display assembly and a first connection device is connected to a second connection device, consistent with the present disclosure.

FIG. 6 is another schematic diagram showing directions when a display area of a first display assembly faces a display area of a second display assembly and a first connection device is connected to a second connection device, consistent with the present disclosure.

FIG. 7 is a schematic structural diagram showing a data output apparatus disposed at a laptop computer consistent with the present disclosure.

### DETAILED DESCRIPTION OF THE EMBODIMENTS

Specific embodiments of the present disclosure are hereinafter described with reference to the accompanying drawings. The described embodiments are merely examples of the present disclosure and should not be regarded as limitations of this application. All other embodiments obtained by those of ordinary skill in the art without creative efforts fall within the scope of protection of the present disclosure.

In the present disclosure, reference is made to “some embodiments” which describe a subset of all possible embodiments, but it is understood that “some embodiments” may be the same subset or a different subset of all possible embodiments, and can be combined with each other without conflict.

The terms “first/second/third” involved are only used to distinguish similar objects and do not represent a specific ordering of objects. It is understood that “first/second/third” can be used interchangeably if permitted. The specific order or sequence may be changed such that the embodiments of the present disclosure described herein can be implemented in an order other than that illustrated or described herein.

Unless otherwise defined, all technical and scientific terms used herein have the same meaning as commonly understood by those of ordinary skill in the art in the technical field to which the present disclosure belongs. The terminology used herein is for the purpose of describing the present disclosure only and is not intended to limit the scope of the present disclosure.

In practical applications, after display data is generated by a processing apparatus, the display data can be output through a display device of the processing apparatus itself or a display device associated with the processing apparatus. For example, after the display data is generated by a laptop computer, the display data can be output through the display screen of the notebook computer. The display data can also be output through the display screen of a television set that has a communication connection with the laptop computer.

However, the display devices, including the display screen of the laptop computer and the display screen of the television, are set up in a single manner and cannot display the display data of the laptop computer with flexibility and diversity.

The present disclosure provides a data output apparatus and a data output system, to at least partially alleviate the above problems.

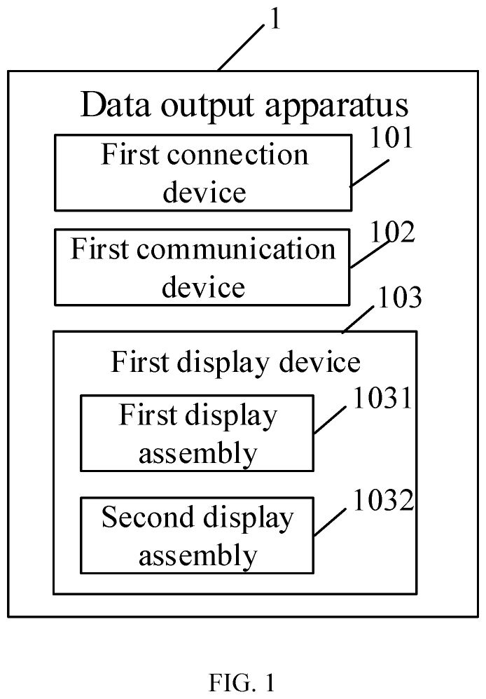

The present disclosure provides a data output apparatus. FIG. 1 is a schematic structural diagram showing a data output apparatus provided by the present disclosure. As shown in FIG. 1, in one embodiment, the data output apparatus includes:
a first connection device 101, capable of detachably connecting a second connection device of a processing apparatus to maintain a positional relationship between the data output apparatus 1 and the processing apparatus;
a first communication device 102, configured to receive display data sent from the processing apparatus; and
a first display device 103, configured to output the display data.

The first display device 103 includes a first display assembly 1031 and a second display assembly 1032.

In one embodiment, the processing apparatus may include a device capable of outputting the display data. For example, the processing apparatus may include a display or a television box, and the like.

In another embodiment, the processing apparatus may include a device capable of generating and outputting display data. For example, the processing apparatus may include a computer device, a smart speaker, a mobile phone, etc.

In another embodiment, the processing apparatus may include a device provided with a display screen and capable of outputting the display data, such as a laptop computer, a television, a mobile phone, etc.

In another embodiment, the processing apparatus may include a device that is not provided with a display screen but is able to output the display data, such as a television box, a desktop computer, a speaker, etc.

In one embodiment, the display data may include at least one of image data, video data, or text data.

In one embodiment, the first connection device 101 may include a snap connection device. With the help of the positioning function and the locking function included in the snap connection device, the stable positioning and connection between the first connection device 101 and the second connection device may be realized.

In another embodiment, the first connection device 101 may include a chute connection device. With the help of a curved track or a sliding seat in the chute connection device, a flexible connection between the first connection device 101 and the second connection device may be achieved.

In another embodiment, the first connection device 101 may include a magnetic connection device. With the help of magnets or substances that are able to be mutually adsorbed with the magnets in the magnetic connection device, a flexible and stable connection with the second connection device may be achieved. For example, the substances that are able to be adsorbed to the magnets may include metals or alloys.

In one embodiment, the first connection device 101 may be fixedly or detachably provided at the data output apparatus 1.

In one embodiment, the attitude of the first connection device 101 relative to the data output apparatus 1 may be adjustable and controllable.

In one embodiment, the positional relationship between the data output apparatus 1 and the processing apparatus may include the relative pose relationship between the data output apparatus 1 and the processing apparatus.

In one embodiment, the first communication device 102 may receive the display data sent by the processing apparatus through a wired connection and/or a wireless connection between the first communication device 102 and the processing apparatus. For example, the first communication device 102 may be provided with a communication assembly capable of supporting at least one communication mode.

In one embodiment, the size of the display area of the first display assembly 1031 may be different from the size of the display area of the second display assembly 1032.

In one embodiment, the data output form of the first display assembly 1031 may be different from the data output form of the second display assembly 1032. For example, the first display assembly 1031 may output the display data in the form of dynamic scrolling, and the second display assembly 1032 may output the display data in a static manner. As another example, the first display assembly 1031 may output the display data in the form of video, and the second display assembly 1032 may output the display data in the form of a single frame picture.

In one embodiment, the first display assembly 1031 and the second display assembly 1032 may output display data at the same time.

In one embodiment, the first display assembly 1031 and the second display assembly 1032 may output display data in a time-division format. For example, the first display assembly 1031 may output display data in the first period, and the second display assembly 1032 may output the display data in the second period after the end of the first period.

In one embodiment, the first display assembly 1031 may output the first part of the display data, and the second display assembly 1032 may output the second part of the display data. The display data may include the first part of the display data and the second part of the display data. The processing apparatus and/or the data output apparatus 1 may process the display data to determine the first part of the data and the second part of the data, and control the first display assembly 1031 and the second display assembly 1032 to respectively display the first part of the data and the second part of the data.

In one embodiment, the first display assembly 1031 and the second display assembly 1032 may respectively output different types of data in the display data. For example, the first type of data in the display data may be output through the first display assembly 1031 output, and the second type of data in the display data may be output through the second display assembly 1032. The type of data displayed by the first display assembly 1031 and the type of data displayed by the second display assembly 1032 may be determined by the processing apparatus and/or the data output apparatus 1, or may be determined based on the data format types that the first display assembly 1031 and the second display assembly 1032 are able to respectively output.

In one embodiment, the processing apparatus and/or the data output apparatus 1 may control at least one of the first display assembly 1031 and the second display assembly 1032 to output the display data.

In one embodiment, in addition to the first display assembly 1031 and the second display assembly 1032, the first display device 103 may further include at least one display assembly. For example, the size of the at least one display assembly may be the same as or different from the size of the first display assembly 1031 and the second display assembly 1032.

In the data output apparatus provided by the present disclosure, the first connection device may be detachably connected to the second connection device of the processing apparatus to maintain the positional relationship between the data output apparatus and the processing apparatus. Therefore, the data output apparatus may be stably fixed relative to the processing apparatus through the first connection device. Since the first connection device may be detachably connected to the second connection device of the processing apparatus, the connection manner between the data output apparatus and the processing apparatus may be more flexible. Further, when the first communication device receives the display data sent by the processing apparatus, the display data may be flexibly displayed through the first display assembly and the second display assembly included in the first display device. By controlling the data output manners of the first display assembly and the second display assembly, controllable and diversified display of display data may be achieved. Therefore, the data output apparatus provided by the embodiments of the present disclosure may be able to realize flexible and diversified output of the display data sent by the processing apparatus through the cooperation of the first display assembly and the second display assembly in the first connection device and the first display device.

In the data output apparatus 1 provided by the embodiment of the present disclosure, the first display assembly 1031 may be disposed at a first side of the data output apparatus 1; the second display assembly 1032 may be disposed at a second side of the data output apparatus 1, and the first side and the second side may be opposite to each other.

In one embodiment, the first side may include one of sides of the data output apparatus 1 with a surface area larger than a first threshold. For example, the first side may be different from the side on which the first connection device 101 is disposed, to reduce blocking of the first display assembly 1031 by the first connection device 101. The first threshold may include the surface area of the first display assembly 1031.

In one embodiment, the second side may include a side of the data output apparatus 1 with a surface area larger than a second threshold. For example, the second side may be different from the side on which the first connection device 101 is disposed, to reduce blocking of the second display assembly 1032 by the first connection device 101. The second threshold may include the surface area of the second display assembly 1032.

In one embodiment, the data output apparatus 1 may have a sheet-like or plate-like form. Therefore, the data output apparatus 1 may include the first side and the second side, and four connection sides connecting the first side and the second side. For example, the surface area of the first side may be larger than the first threshold to facilitate the setting of the first display assembly 1031, and the surface area of the second side may be larger than the second threshold to facilitate the setting of the second display assembly 1032. For example, any one of the connection sides may be used to set the first connection device 101.

In one embodiment, the first display assembly 1031 and the second display assembly 1032 may be disposed at a same side of the data output apparatus 1. For example, both the first display assembly 1031 and the second display assembly 1032 may be disposed at the first side or the second side at the same time.

In another embodiment, the first display assembly 1031 and the second display assembly 1032 may also be disposed at adjacent sides of the data output apparatus 1.

In one embodiment, the relative position between the first display assembly 1031 and the second display assembly 1032 may be fixed or adjustable. For example, the height of the first display assembly 1031 and the second display assembly 1032 may be different. Combined with the arrangement of the first display assembly 1031 and the second display assembly 1032 on the first side and the second side respectively, output of the display data at different angles, orientations or height respectively may be achieved.

In the data output apparatus provided by the embodiments of the present disclosure, the first display assembly and the second display assembly may be respectively disposed at two opposite sides of the data output apparatus. Therefore, through the first display assembly and the second display assembly, the display data may be output in two opposite directions respectively, thereby improving the diversity and flexibility of the output of the display data. Further, regardless of the any change of the positional relationship between the data output apparatus and the processing apparatus, through the mutual cooperation between the first display assembly and the second display assembly, the output effect of the display data may still be effectively improved.

In one embodiment, in the data output apparatus 1, the display principle of the first display assembly 1031 may be different from the display principle of the second display assembly 1032.

As schematically shown in FIG. 8, the first display assembly 1031 includes first display units 10311 and light-emitting units 10312. The light emitted by the light-emitting units may pass through the first display units to output the display data. The second display assembly 1032 includes second display units 10321, and the second display units 10321 may reflect the light of the environment where the data output apparatus 1 is located to display the display data.

In one embodiment, the display principle of the first display assembly 1031 and the display principle of the second display assembly 1032 may be related to the physical structure and circuit structure of the first display assembly 1031 and the second display assembly 1032 respectively. For example, the display principle of the first display assembly 1031 and the display principle of the second display assembly 1032 may be related to the data refresh mode, data display type and electrical power consumption status of the first display assembly 1031 and the second display assembly 1032 respectively.

In one embodiment, the number of the light-emitting units may be at least one. For example, when the first display assembly 1031 is a liquid crystal display (LCD), the light-emitting units may include backlight sources of the LCD. For another embodiment, when the first display assembly 1031 is an organic light-emitting diode (OLED), the light-emitting units may include an array of light-emitting diodes.

In one embodiment, one first display unit may include a unit capable of transmitting light emitted by one corresponding light-emitting unit to the environment where the data output apparatus 1 is located. For example, the first display unit may include a liquid crystal solution.

In one embodiment, the second display units may include a display unit capable of reflecting light of the environment in which the data output apparatus 1 is located.

In one embodiment, the second display assembly 1032 may be an electronic ink screen (Eink). For example, the second display assembly 1032 may be provided with microcapsules with a number larger than a quantity threshold. After being powered on, in response to an operation instruction for outputting the display data, the second display assembly 1032 may control electronic particles of different colors in the microcapsules to move. After the movement of the particles is completed, the output of the display data may be realized through the light reflection operation of the second display units.

In one embodiment, the display principle of the first display assembly 1031 may be different from the display principle of the second display assembly 1032. Therefore, the type of display screen included in the first display assembly 1031 may be different from the type of the display screen in the second display assembly 1032.

In one embodiment, the display principle of the first display assembly 1031 may be different from the display principle of the second display assembly 1032. Therefore, the data display colors of the first display assembly 1031 and the display colors of the second display assembly 1032 may be different. For example, the first display assembly 1031 may output color data, and the second display assembly may output black and white data. The colorful part of the display data may be presented through the first display assembly 1031, and the black and white part of the display data may be presented through the second display assembly 1032.

In one embodiment, the display principle of the first display assembly 1031 may be different from the display principle of the second display assembly 1032. Therefore, the refresh rate of the first display assembly 1031 may be higher than the refresh rate of the second display assembly 1032. The first display assembly 1031 may present animation data, and the second display assembly 1032 may present image data or text data.

In one embodiment, the display principle of the first display assembly 1031 may be different from the display principle of the second display assembly 1032, and the first display assembly 1032 may include the light-emitting units. Therefore, the display electrical power consumption of the first display assembly 1031 and the display electrical power consumption of the second display assembly 1032 may be different. In this case, how the first display assembly 1031 and/or the second display assembly 1032 output the display data may be controlled according to the remaining state of the available electrical power of the data output apparatus 1 or the processing apparatus.

In some other embodiments, the display principle of the first display assembly 1031 may be same as the display principle of the second display assembly 1032. For example, both the first display assembly 1031 and the second display assembly 1032 may be LCD or Eink.

In the data output apparatus provided by the present disclosure, the display principle of the first display assembly may be different from the display principle of the second display assembly. Therefore, the processing apparatus and/or the data output apparatus may control the display status of the first display assembly and the second display assembly based on the above display principles. Since the first display assembly includes the first display units and the light-emitting units, and the light emitted by the light-emitting units may pass through the first display units to output the display data, vivid output of the display data may be realized through the first display assembly. Also, the second display assembly may include the second display units and the second display units may output the display data by reflecting the light of the environment where the data processing apparatus is located, the second display assembly may be used to output the display data with a lower electrical power consumption. Therefore, through the first display assembly and the second display assembly, diversified output of the display data may be achieved.

In one embodiment, the first communication device 102 and the first connection device 101 may be provided at the third side of the data output apparatus 1. When the first connection device 101 is connected to the second connection device, the first communication device 102 may receive the electrical power transmitted by the second connection device. The orientation of the third side may be the same as the orientation of the first side.

In one embodiment, when the first connection device 101 is connected to the second connection device, the first communication device 102 may be electrically connected to an electrical power output port included in the second connection device, thereby receiving the electrical power transmitted by the electrical power output port. That is, the first communication device 102 may have dual functions of data transmission and electrical power transmission.

In one embodiment, the first communication device 102 may include a first transmission assembly and a second transmission assembly. When the first connection device 101 is connected to the second connection device of the processing apparatus, the first transmission assembly and the second transmission assembly may be electrically connected to the data transmission port and the electrical power output port included in the second connection device respectively. Therefore, the first transmission assembly may receive the display data output by the above-mentioned data transmission port, and the second transmission assembly may receive the electrical power transmitted by the electrical power output port. For example, in one embodiment, the first connection device 101 may be connected to the second connection device in a magnetic manner. The first transmission assembly and the second transmission assembly, as well as the above-mentioned data transmission port and electrical power transmission port may all be pogo pins. Therefore, through the contact between the pogo pin ports, the parallel transmission of the electrical power and the display data between the processing apparatus and the data output apparatus 1 may be realized.

In various embodiments, the first communication device 102 may continuously or intermittently receive the electrical power transmitted by the processing apparatus through the second connection device.

In one embodiment, the third side may be located on the same side of the data output apparatus 1 as the first side. For example, the third side and the first side may be coplanar or co-curved, the first display assembly 1031 may be disposed at a first portion of a specific plane or curved surface of the data output apparatus 1, and the first connection device 101 and the first communication device 102 may be disposed at a second portion of the specific plane or curved surface of the data output apparatus 1. As another example, in some other embodiments, the third side may be not coplanar with the first side, the first side and the third side may be adjacent sides on the same side of the data output apparatus 1.

In another embodiment, the third side may be perpendicular to the first side and the second side. For example, the surface area of the third side may be larger than the surface area of the first connection device 101 and the first communication device 102. Therefore, the first connection device 101 provided at the third side may be stably connected to the second connection device. At the same time, on the basis of the first connection device 101 being stably connected to the second connection device, the first communication device 102 may also realize stable transmission of the display data and the electrical power with the second connection device. Also, since the third side, the first side and the second side are not on the same side of the data output apparatus 1, the first connection device 101 may be provided at the third side, to reduce the size and volume of the data output apparatus 1.

In the data output apparatus provided by the present disclosure, the first communication device and the first connection device may be disposed at the third side of the data output apparatus, and the orientation of the third side may be the same as the orientation of the first side, thereby reducing the probability of obstruction of the first display assembly and the second display assembly by the first communication device and the first connection device. The connection area of the first connection device may be increased, thereby improving the stability of the connection between the first connection device and the second connection device. Further, when the first connection device is connected to the second connection device, the first communication device may receive the electrical power transmitted by the second connection device, thereby realizing parallel transmission of the electrical power and the display data between the processing apparatus and the data output apparatus through the first communication device as the single device. The electrical power and display data transmission structure of the data output apparatus and the processing apparatus may be simplified. Further, the stable connection between the first connection device and the second connection device through the third side and the first side with the same orientation may also improve the stability of data and electrical power transmission between the first connection device and the second connection device.

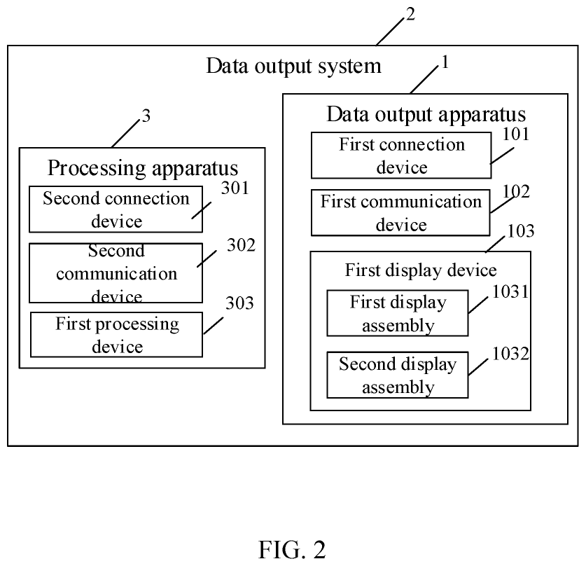

The present disclosure also provides a data output system. In one embodiment shown in FIG. 2, which shows a structure of the data output system provided by the present embodiment, the data output system may include a data output apparatus 1 and a processing apparatus 3.

The data output apparatus 1 may include:
a first connection device 101 capable of being detachably connected to a second connection device 301 of a processing apparatus 3, to maintain the positional relationship between the data output apparatus 1 and the processing apparatus 3;
a first communication device 102, configured to receive display data transmitted by the processing apparatus 3; and
a first display device 103 including a first display assembly 1031 and a second display assembly 1032, configured to output the display data.

The processing apparatus 3 may include:
a second connection device 301, configured to be detachably connected to the first connection device 101;
a second communication device 302, configured to send the display data to the first communication device 102; and
a first processing device 302, configured to generate the display data.

The data output apparatus 1 in the data output system 2 may be any data output apparatus 1 provided by various embodiments of the present disclosure.

In one embodiment, the second communication device 302 may establish a wired or wireless communication connection with the first communication device 102.

In one embodiment, when the first connection device 101 is connected to the second connection device 301, the second communication device 302 may be electrically connected to the first communication device 102. Therefore, the second communication device 302 may transmit electrical power to the first communication device 102. The second communication device 302 and the first communication device 102 may also establish a data transmission channel through the above-mentioned electrical connection, thereby realizing parallel transmission of the electrical power and the data between the processing apparatus 3 and the data output apparatus 1. For example, in one embodiment, the second communication device 302 and the first communication device 102 may both be pogo pins. Therefore, when the first connection device 101 and the second connection device 301 are connected by magnetic attraction, the second communication device 302 may be in electrical contact with the first communication device 102, thereby realizing the transmission of the electrical power and the display data between the first communication device 102 and the second communication device 302.

In another embodiment, when the first connection device 101 is connected to the second connection device 301, the second communication device 302 may be electrically connected to the first communication device 102. Therefore, the second communication device 302 may transmit the electrical power to the first communication device 102. At the same time, a wireless communication connection including a Bluetooth (Blue Tooth, BT) connection or a Wi-Fi connection may also be established between the first communication device 102 and the second communication device 302 such that the second communication device 302 may transmit the display data to the first communication device 102 through the wireless communication connection.

In another embodiment, when the first connection device 101 is connected to the second connection device 301, the second communication device 302 and the first communication device 102 may not be electrically connected, and a wireless communication connection may be established between the second communication device 302 and the first communication device 102.

In one embodiment, when the second communication device 302 establishes a communication connection with the first communication device 102 for the first time, the processing apparatus 3 may automatically search for the data output apparatus 1 or the data output apparatus 1 may automatically search for the processing apparatus 3. The processing apparatus 3 or the data output apparatus 1 may also confirm the information between the processing apparatus 3 and the data output apparatus 1 automatically or based on the information manually input by the user, thereby establishing a communication connection between the processing apparatus 3 and the data output apparatus 1.

In one embodiment, the processing apparatus 3 may determine a condition for transmitting the display data automatically or in response to a user's input operation. When the above condition is met, the display data may be transmitted to the data output apparatus 1. For example, the condition may include a working mode condition of the processing apparatus 3 and/or an application condition running in the processing apparatus 3. The working mode conditions may include sending display data to the data output apparatus 1 when the processing apparatus 3 is in the target mode, and the display data is not sent to the data output apparatus 1 when the processing apparatus 3 is in other modes. The application condition may include that: the processing apparatus 3 determines the prompt data related to the update status of the target application as the display data and sends the display data to the data output apparatus when the processing apparatus 3 detects an update of the target application; and does not perform the operation of determining and sending display data when the status of other applications is updated. The above target application may include an email, a social software, etc.

In one embodiment, the first processing device 303 may be a processor of the processing apparatus 3. For example, the processor may be an application specific integrated circuit (ASIC), a digital signal processor (DSP), a digital signal processing device (DSPD), a programmable logic device (PLD), a field programmable gate array (FPGA), a central processing unit (CPU), a controller, a micro controller unit (MCU), or a microprocessor.

In one embodiment, the first processing device 303 may generate the display data including video data, image data, or text data.

In the data output system provided by the present disclosure, the first connection device in the data output apparatus may be detachably connected to the second connection device of the processing apparatus to maintain the positional relationship between the data output apparatus and the processing apparatus. Therefore, stable fixation of the data output apparatus with respect to the processing apparatus may be realized through the first connection device. Also, since the first connection device may be detachably connected to the second connection device of the processing apparatus, the connection between the data output apparatus and the processing apparatus may be more flexible. At the same time, the first connection device may be detachably connected to the second connection device of the processing apparatus. After the communication device receives the display data sent by the processing apparatus, the display data may be flexibly displayed through the first display assembly and the second display assembly included in the first display device. By controlling the data output manners of the first display assembly and the second display assembly, controllable and diversified display of the display data may be realized.

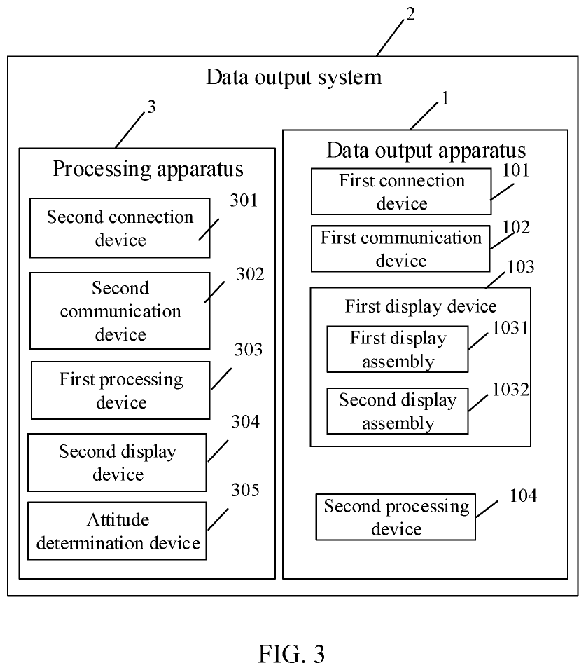

In one embodiment shown in FIG. 3 which is another structure of the data output system 2, the first display assembly 1031 may be disposed at a first side of the data output apparatus 1; the second display assembly 1032 may be disposed at a second side of the data output apparatus 1, and the first side and the second side may be opposite to each other.

The processing apparatus 3 may further include a second display device 304. When the first connection device 101 is connected to the second connection device 301, the orientation of the display area of the first display assembly 1031 may be consistent with the orientation of the display area of the second display device 304.

In one embodiment, the electrical power consumption when the first display assembly 1031 outputs the display data may be larger than the electrical power consumption when the second display assembly 1032 outputs the second display data.

In one embodiment, the display principle of the second display device 304 may be the same as that of the first display assembly 1031. For example, the second display device 304 and the first display assembly 1031 may both be LCDs.

In one embodiment, the display principle of the second display device 304 may be different from the display principles of the first display assembly 1031 and the second display assembly 1032. For example, the second display device 304 may be an OLED, the first display assembly 1031 may be an LCD, and the second display assembly 1032 may be an electronic ink screen (Eink).

In one embodiment, the data display mode of the second display device 304 may be different from the data display modes of the first display assembly 1031 and the second display assembly 1032.

For example, the data display mode may include a presentation method of the content contained in the display data. For example, the second display device 304 may completely present the entire content of the display data, and the first display assembly 1031 and the second display assembly 1032 may respectively present a portion of the displayed data.

For example, the data display mode may include a refresh mode of display data. For example, the second display device 304 may refresh the display data at a first refresh rate, the first display assembly 1031 may refresh the display data at a second refresh rate, and the second display assembly 1032 may refresh the display data at a third refresh rate. The first refresh rate may be different from the second refresh rate and the third refresh rate.

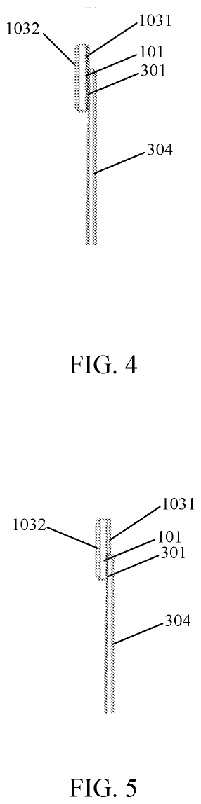

FIG. 4 is a schematic diagram showing the orientation of the display area of the first display assembly and the orientation of the display area of the second display assembly when the first connection device is connected to the second connection device.

As shown in FIG. 4, in one embodiment, when the first connection device 101 is connected to the second connection device 301, the orientation of the display area of the first display assembly 1031 may be consistent with the orientation of the display area of the second display device 304; and, the orientation of the second side where the second display assembly 1032 is located may be opposite to the orientation of the first side where the first display assembly 1031 is located.

As shown in FIG. 4, the second connection device 301 and the second communication device 302 (not shown in the figure) may be disposed at the side of the second display device 304 away from the display area; and the first connection device 101 may be disposed at a position where the data output apparatus 1 is connected to the second connection device 301 in FIG. 4.

As shown in FIG. 4, the third side where the first communication device 102 and the first connection device 101 are disposed may be located on the same side of the data output apparatus 1 as the first side, and the third side may be coplanar with the first side.

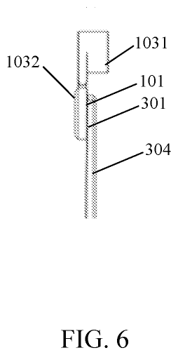

FIG. 5 is another schematic diagram showing the orientation of the display area of the first display assembly and the orientation of the display area of the second display assembly when the first connection device is connected to the second connection device.

In the embodiment shown in FIG. 5, the connection between the first connection device 101 and the second connection device 102 may be same as the embodiment shown in FIG. 4.

As shown in FIG. 4, in one embodiment, when the first connection device 101 is connected to the second connection device 301, the orientation of the display area of the first display assembly 1031 may be consistent with the orientation of the display area of the second display device 304; and, the orientation of the second side where the second display assembly 1032 is located may be opposite to the orientation of the first side where the first display assembly 1031 is located.

As shown in FIG. 5, the third side and the first side may be located on one same side of the data output apparatus 1, and the third side and the second side may be parallel to each other.

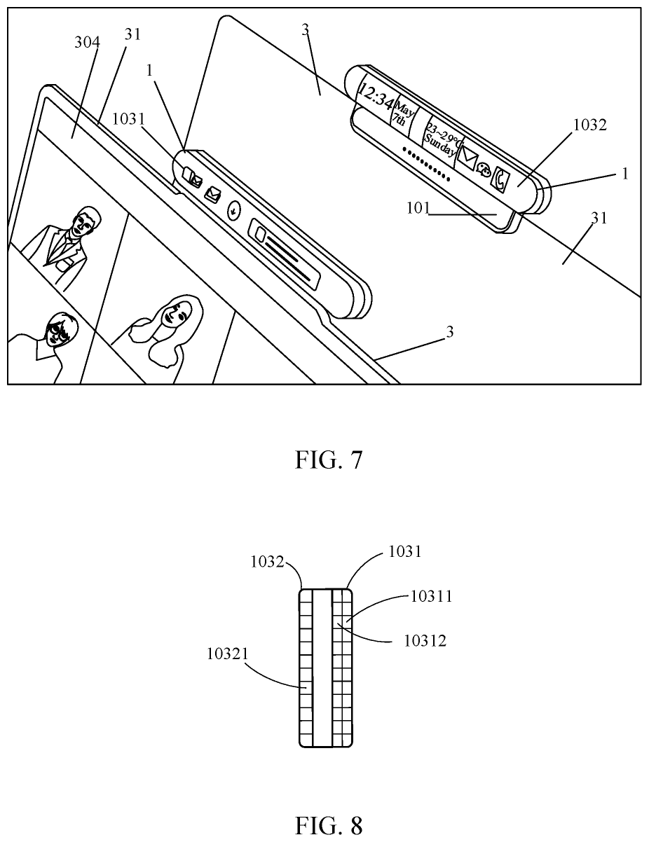

FIG. 6 is another schematic diagram showing the orientation of the display area of the first display assembly and the orientation of the display area of the second display assembly when the first connection device is connected to the second connection device.

In the embodiment shown in FIG. 6, the connection between the first connection device 101 and the second connection device 102 may be same as the embodiments shown in FIG. 4 and FIG. 5.

As shown in FIG. 6, in one embodiment, the orientation of the display area of the first display assembly 1031 may be adjustable. That is, the first display assembly 1031 may rotate in a plane perpendicular to the second display assembly 1032. For example, when the first connection device 101 is connected with the second connection device 301, the orientation of the display area of the first display assembly 1031 may be adjusted to be consistent with the orientation of the display area of the second display device 304.

In one embodiment, the first display assembly 1031 may include a display assembly that requires the help of a light-emitting unit to output the display data. For example, the first display assembly 1031 may be an LCD assembly or an OLED assembly.

In one embodiment, the second display assembly 1032 may include an assembly that is able to output the display data by reflecting ambient light. For example, the second display assembly 1032 may include an electronic ink screen (Eink).

In the data output system provided by the present disclosure, the first display assembly and the second display assembly may be respectively disposed at two opposite sides of the data output apparatus, and the first connection device may be connected to the second connection device. The orientation of the display area of the first display assembly may be consistent with the orientation of the display area of the second connection device. Therefore, outputting the display data through the first display assembly may improve the display effect of the second display device. On this basis, during the process of outputting the display data through the second display assembly, adjusting the data output mode of the second display assembly may enable diversified output of the display data. Also, since the electrical power consumption of the first display assembly when outputting the display data is larger than the electrical power consumption of the second display assembly when outputting the display data, the display status of the first display assembly and the second display assembly may be flexibly selected and controlled according to the electrical power consumption of the first display assembly and the second display assembly. The display data may be output in a targeted manner through the data output apparatus. Further, based on the electrical power consumption of the first display assembly and the second display assembly, the display status of the first display assembly and the second display assembly may be controlled, to improve the display data output effect while taking into account the electrical power consumption status of the two display assemblies. A balance between the display data output effect and the electrical power consumption status of the two display assemblies may be achieved.

In the data output system 2, the processing apparatus 3 further includes:
a first body 31 and a second body 32 connected through a connection member 33 (as schematically shown in FIG. 9), where the relative positional relationship between the first body and the second body may change; and
an attitude determination device 305, configured to determine the relative positional relationship.

The second display device 304 may be disposed at the first body.

The first processing device 303 may control the display of the first display device through the second communication device 302 based on the relative positional relationship.

In one embodiment, the first body and the second body may be connected through a rotating shaft. The relative positional relationship between the first body and the second body may be changed by rotating around the rotating shaft. For example, the processing apparatus 3 at this time may include a flip phone, a folding screen phone, a folding screen notebook, a folding screen tablet, etc.

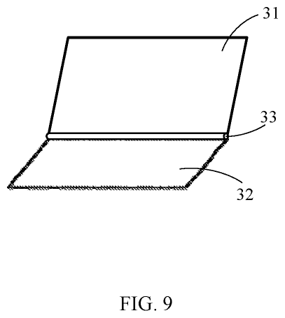

FIG. 7 illustrates one embodiment where the data output apparatus is disposed at a laptop computer. As shown in FIG. 7, in one embodiment, the second display device 304 may be disposed at the first side of the first body, and the second side of the first body may be a protective shell of the laptop computer.

As shown in FIG. 7, when the data output apparatus 1 is connected to the laptop computer 3 through the first connection device 101, the orientation of the display area of the first display assembly 1031 may be consistent with the orientation of the display area of the second display device 304. The orientation of the display area of the second display assembly 1032 may be opposite to the orientation of the display area of the first display assembly 1031 and may be opposite to the orientation of the display area of the second display device 304.

For example, in one embodiment, the first display assembly 1031 may be an LCD or OLED. The display data output by the laptop computer may be output in the form of continuous, dynamically changing, colorful images or videos through the first display assembly 1031. The second display assembly 1032 may be an electronic ink screen, and the display data output by the laptop computer may be output in black and white, static, or text form.

In one embodiment, the relative positional relationship may include the angle between the first body and the second body, or the facing or opposite relationship between the first body and the second body.

In one embodiment, the attitude determination device 305 may include at least one sensor. For example, the at least one sensor may include a gravity sensor, a distance sensor, a steering angle sensor, etc.

For example, the at least one sensor may include at least two gravity sensors, and the at least two gravity sensors may be respectively disposed at the first body and the second body. The tilt angles of the first body and the second body may be determined based on the detection data of the at least two gravity sensors, to determine the angle between the first body and the second body.

For example, at least one distance sensor may be used to detect the distance between the first body and the second body, and the orientation relationship between the first body and the second body may be determined based on the distance.

For example, a steering angle sensor may be provided at the rotation axis for detecting the rotation angle of the first body and/or the second body around the rotation axis. Based on the above rotation angle, the angle or orientation between the first body and the second body may also be determined.

In some embodiments, the first processing device 303 may control the display of the first display device in any of the following ways.

In one way, the first processing device 303 may obtain the relative positional relationship and the association relationship, and determine a target display assembly from the first display assembly 1031 and the first display assembly 1032. For example, the association relationship may include a corresponding relationship between the relative positional relationship and the first display assembly 1031 and the second display assembly 1032 included in the first display device 103.

In another way, the first processing device 303 may detect the user orientation of the user of the processing apparatus 3, and then control the display status of the first display assembly 1031 and the second display assembly 1032 included in the first display device 103 through the second communication device 302 based on the user orientation and relative positional relationship.

In another way, the display status of group 1032 may detect the user status and user orientation of the user of the processing apparatus 3, and determine the user's demand probability for the display data. Then, a target user who needs to obtain the display data in real time based on the demand probability may be determined, and a target display assembly from the first display assembly 1031 and the first display assembly 1032 may be determined according to the relative positional relationship and the user orientation of the target user. The target display assembly may be controlled to output the display data to increase the probability that the target user is able to obtain the display data.

In the data output system of the present disclosure, the first body and the second body of the processing apparatus may be connected through the connection member, and the second display device may be disposed at the first body. In this way, the relative positional relationship between the second display device and the second body can be flexibly adjusted through the connection member. Moreover, after the attitude determination device determines the relative positional relationship between the first body and the second body, the first processing device controls the display of the first display device through the second communication device based on the relative positional relationship, so that the display of the first display device can be controlled according to the processing apparatus. The relative positional relationship between the first body and the second body automatically controls the display state of the first display device, thereby flexibly meeting the demand for display data output.

In one embodiment, in the data output system 2, when the relative positional relationship is a first positional relationship, the first processing device 303 may control the first display assembly 1031 to display the display data through the second communication device 302.

When the first connection device 101 is connected to the second connection device 301, the orientation of the display area of the first display assembly 1031 may be consistent with the orientation of the display area of the second display device 304. The first positional relationship may include that the second display device 304 is facing away from the second body, or the first body and the second body satisfy the coplanarity condition.

In one embodiment, the second display device 304 faces away from the second body may include an included angle of 360 degrees between the first body and the second body.

In one embodiment, the first body and the second body satisfy the coplanarity condition, may include an included angle between the first body and the second body being 180 degrees.

In one embodiment, when the relative positional relationship is the first positional relationship and the second display device 304 is in the data display state, the processing apparatus 3 may not transmit electrical power and display data to the data output apparatus 1 to reduce electrical power consumption of the processing apparatus 3.

In one embodiment, the first positional relationship may be determined by a gravity sensor and a steering angle sensor.

In one embodiment, when the relative positional relationship is not the first positional relationship, for example, when the relative positional relationship indicates that the angle between the first body and the second body is a right angle, the first display assembly 1031 and/or the second display assembly 1032 may be controlled to output the display data. For example, when outputting the display data through the first display assembly 1031, the first display assembly 1031 may be used as an additional display area or an extended display area of the second display device 304, thereby improving the data display effect of the second display device 304 or expanding the display area of the second display device 304.

In one embodiment, when the relative positional relationship is not the first positional relationship, for example, when the relative positional relationship indicates that the angle between the first body and the second body is an obtuse angle, such as 120 degrees or 150 degrees, the first display assembly 1031 may be controlled to output the display data. The first display assembly 1031 may be used as an additional display area or an extended display area of the second display device 304, thereby improving the data display effect of the second display device 304 or expanding the display area of the second display device 304.

In one embodiment, regardless of whether the relative positional relationship is the first positional relationship, the target user may be determined from users of the processing apparatus 3 according to the user status described in the previous embodiments. Then, based on the user orientation and relative positional relationship of the target user, the target display assembly may be determined from the first display assembly 1031 and the second display assembly 1032, and then the target display assembly may be controlled to output the display data, thereby increasing the probability that the target user is able to obtain the display data.

For example, when the relative positional relationship is the first positional relationship, the first display assembly 1031 may be directly controlled to display the display data. The determination process of the target display assembly may be simplified and the probability that the users of the processing apparatus 3 obtain the display data may be increased.

In the data output system provided by the embodiments of the present disclosure, when the first connection device is connected to the second connection device, the orientation of the display area of the first display assembly may be consistent with the orientation of the display area of the second display device. Therefore, when the second display device of the processing apparatus faces away from the second body or the first body and the second body meet the coplanarity condition, the first processing device may control the first display assembly to display the display data through the second communication device. The display state of the first display assembly may be automatically controlled based on the relative positional relationship between the first body and the second body of the processing apparatus, and also, the display effect of the display data by the second display device may be improved.

In one embodiment, in the data output system 2, when the relative positional relationship is a second positional relationship, the first processing device 303 may control the second display assembly 1032 to display the display data through the second communication device 302.

When the first connection device 101 is connected to the second connection device 301, the orientation of the display area of the second display assembly 1032 may be opposite to the orientation of the display area of the second display device 304. The second positional relationship may include that the second display device 304 is facing the second body.

In one embodiment, when the relative positional relationship is not the second positional relationship but the first positional relationship, the first display assembly 1031 may be controlled to display the display data.

In one embodiment, the second display device 304 faces the second body may include that the included angle between the first body and the second body is an acute angle or 0 degree.

In one embodiment, the second positional relationship may be determined by a gravity sensor, a distance sensor, and a steering angle sensor.

In one embodiment, regardless of whether the relative positional relationship is the second positional relationship, the target user may be determined from users of the processing apparatus 3 according to the user status described in the previous embodiments. Then, based on the user orientation and relative positional relationship of the target user, the target display assembly may be determined from the first display assembly 1031 and the second display assembly 1032, and then the target display assembly may be controlled to output the display data, thereby increasing the probability that the target user is able to obtain the display data.

For example, when the relative positional relationship is the second positional relationship, the second display assembly 1032 may be directly controlled to display the display data. The determination process of the target display assembly may be simplified and the probability that the users of the processing apparatus 3 obtain the display data may be increased.

In the data output system provided by the embodiments of the present disclosure, when the first connection device is connected to the second connection device, the orientation of the display area of the second display assembly may be opposite the orientation of the display area of the second display device. Therefore, when the relative positional relationship between the first body and the second body is that the second display device faces the second body, the first processing device may control the second display assembly to display the display data through the second communication device. The display state of the first display assembly may be automatically controlled based on the relative positional relationship between the first body and the second body of the processing apparatus, and also, the display effect of the display data by the second display device may be improved.

In one embodiment, in the data output system 2, the electrical power consumption when the processing apparatus 3 is in the first mode may be larger than the electrical power consumption when the processing apparatus 3 is in the second mode.

When the processing apparatus 3 is in the first mode and the second display device 304 is in the display state, the first processing device 303 may transmit the electrical power and the display data to the first display device 103 through the second communication device 302 based on the first transmission mode.

When the processing apparatus 3 is in the second mode and the second display device 304 is in a non-display state, the first processing device 303 may transmit the electrical power and the display data to the first display device 103 through the second communication device 302 based on the second transmission mode.

The first transmission mode may be different from the second transmission mode.

In one embodiment, the first mode may include a mode in which the processing apparatus 3 is in a running state. In this mode, the second display device 304 may be in an activated state. Therefore, the processing apparatus 3 may output the display data generated by the first processing device 303 through the second display device 304.

In one embodiment, the second mode may include a mode in which data generated by the processing apparatus 3 is no longer transmitted to the second display device 304, and in this mode, the second display device 304 may be in an inactive state.

In one implementation, the first transmission mode may include that the first processing device 303 continuously transmits the electrical power and the display data to the first display device 103. For example, the first processing device 303 may continuously transmit the electrical power to the data output apparatus 1, and transmit the display data to the first display device 103 using the refresh frequency of the display data as the transmission frequency. For example, based on the user orientation of the user of the processing apparatus 3, the user status, and the relative positional relationship between the first body and the second body, the target display assembly may be determined from the first display assembly 1031 and the second display assembly 1032, and the display data may be output through the target display assembly.

In one embodiment, the second transmission mode may include that the first processing device 303 intermittently transmits the electrical power and the display data to the first display device 103. For example, the first processing device 303 may transmit the electrical power and the display data at specified time intervals to the first display device 103. For example, based on the user orientation of the user of the processing apparatus 3, the user status, and the relative positional relationship between the first body and the second body, the target display assembly may be determined from the first display assembly 1031 and the second display assembly 1032, and the display data may be output through the target display assembly.

For example, when the angle between the first body and the second body is 120 degrees, the user orientation indicates that the first user and the second user of the processing apparatus 3 are respectively located at a position facing away from the second display device 304 and a position facing the second display device 304, and the second display device 304 is in a state of not displaying data, both the first display assembly 1031 and the second display assembly 1032 may be determined as target display assemblies, and the first display assembly 1031 and the second display assembly 1032 may be controlled to respectively display the above display data through the first processing device 302, thereby reducing the probability that the first user and the second user cannot obtain the display data. When he second display device is in a state of displaying data, the second display assembly 1032 may be determined as the target display assembly, and the second display assembly 1032 may be controlled to output the display data.

In one embodiment, the working mode of the processing apparatus 3 may be related to the relative positional relationship between the first body and the second body. For example, when the first body and the second body are in a closed state, that is, the angle between the first body and the second body is 0 degrees, the second display device 304 may face the second body, and the processing apparatus 3 may switch to the second mode. At this time, the first processing device 303 may transmit the electrical power to the first display device 103 based on the second transmission mode, and output the display data through the second display assembly 1032. As another example, when the first body and the second body meet the coplanarity condition, or the second display device 304 faces the second body, the processing apparatus 3 may switch to the first mode, and the first processing device 303 may transmit the electrical power to the first display device 103 based on the second transmission mode, and output the display data through the first display assembly 1031.

In one embodiment, the first transmission mode and the second transmission mode may be different in the electrical power transmission mode and/or display data transmission mode. For example, the electrical power transmission mode may include at least one of time continuity of electrical power transmission, the amplitude of the electrical power output by the processing apparatus 3, or the type of the electrical power output by the processing apparatus 3. For example, the display data transmission mode may include at least one of time continuity of the display data transmission, the type of the display data transmitted by the processing apparatus 3, or the data amounts of the transmitted display data transmitted by the processing apparatus 3.

In the data output system provided by the present disclosure, the electrical power consumption when the processing apparatus is in the first mode may be larger than the electrical power consumption when the processing apparatus is in the second mode. When the processing apparatus is in the first mode or the second mode, the display state of the second display device may be different. At this time, the first processing device may be capable of transmitting the electrical power and the display data to the first display device based on the transmission mode corresponding to the working mode of the processing apparatus. Therefore, automatic control of the transmission mode of the first processing device according to the working mode of the processing equipment may be achieved.

In one embodiment, for the data output system 2, the second transmission mode may include: in response to the status change of the display data, the first processing device 303 transmits the electrical power to the first display device 103 through the second communication device 302, and transmits the display data after the status change to the first display assembly 1031 and/or a second display assembly 1032.

In one embodiment, when the processing apparatus 3 is in the second mode, the first processing device 303 may continuously detect whether the status of the display data changes.

In one embodiment, when the first processing device 303 intermittently transmits the electrical power and the display data to the first display device 103 based on the second transmission mode, and when the first display assembly 1031 is the target display assembly, since the light-emitting units in the first display assembly 1031 require the help of electrical power to output the display data, the first display assembly 1031 may intermittently output the display data, and when receiving the electrical power and the display data after status change, output the display data after the status change.

In one embodiment, when the first processing device 303 intermittently transmits the electrical power and the display data to the first display device 103 based on the second transmission mode, and when the second display assembly 1032 is the target display assembly, since the second display assembly 1032 outputs the display data through the second display unit reflecting the ambient light, the second display assembly 1032 may still output the display data by reflecting the ambient light during the period when electrical power is not transmitted to the second display assembly 1032, and may output the display state after the status change when receiving the electrical power and the display data after the status change. During the period when no electrical power is received, the display data after the status change may continue to be maintained.

Since the electrical power consumption of the second display assembly 1032 is less than the display electrical power consumption of the first display assembly 1031, when the first processing device 303 intermittently transmits the electrical power and the display data to the first display device 103 based on the second transmission mode, the priority of the second display assembly 1032 for outputting the display data may be higher than the priority of the first display assembly 1031 for outputting the display data, thereby further reducing the electrical power consumption of outputting the display data.

In one embodiment, the processing apparatus 3 may be a laptop computer, the second mode may be a mode in which the display screen of the laptop computer is in an inactive state, and the display data is prompt data in the laptop computer. When the application status of the laptop computer is updated, a processor of the laptop computer may update the prompt data according to the result of the application status update, and transmit the prompt data to the first display device 103 of the data output apparatus 1 such that the prompt data is displayed through the first display assembly 1031 and/or the second display assembly 1032, thereby reducing the probability that the user of the laptop computer misses the application status update. The prompt data may include prompt information generated in the laptop computer because of system update or application status update. For example, the prompt data may include prompt information for application status changes such as emails and social software.

Through the method provided by the foregoing embodiments, based on the user orientation and user status of the laptop computer and the relative positional relationship between the first body and the second body of the laptop computer, the target display assembly may be determined from the first display assembly 1031 and the second display assembly 1032, and the above display data may be output through the target display assembly.

In existing technologies, when a laptop computer is in standby or closed state, the user can only obtain the changing status of the remaining electrical power of the laptop computer through a charging indicator light, but cannot obtain status update data such as email sending and receiving, weather changes, or schedule reminders, resulting in users being unable to obtain the above data in real time.

Through the data output system provided by the embodiments of the present disclosure, when the second display device of the processing apparatus is in a state of not outputting display data, the first processing device may transmit the electrical power to the first display device through the second communication device in response to the status change of the display data, and transmit the display data after the status change to the first display assembly and/or the second display assembly, thereby reducing the possibility that the display data cannot be displayed when the second display device is in a state of not outputting display data.

In one embodiment, for the data output system 2, the processing apparatus 3 may further include a second display device 304 capable of displaying the display data. The electrical power consumption of the second display device 304 may be greater than the electrical power consumption of the first display device 103. The data output apparatus 1 may further include a second processing device 104 for converting the display data to obtain target data. The first display assembly 1031 and/or the second display assembly 1032 may be used to display the target data; and the amount of target data may be smaller than the display data.

In one embodiment, the second processing device 104 may be at least one of an ASIC, a DSP, a DSPD, a PLD, an FPGA, a CPU, a controller, a microcontroller, or a microprocessor.

In one embodiment, the second processing device 104 may obtain the target data by any one of:
performing type conversion on the display data to obtain the target data, including converting image data into text data (for example, according to the data display formats supported by the first display assembly 1031 and/or the second display assembly 1032, performing type-conversion in the display data to obtain the target data);
compressing or intercepting the display data to obtain the target data; or
obtaining theme data or image data corresponding to the display data, and determining the theme data or image data as the target data. The corresponding relationship between the display data and the theme data or image data may be personalized, and the theme data or image data may include electronic pets or holiday greetings.

In the data output system of the present disclosure, the processing apparatus may include the second display device capable of displaying the display data, and the electrical power consumption of the second display device may be greater than the electrical power consumption of the first display device. Therefore, when the display data is displayed through the first display device without being output through the second display device, the data display electrical power consumption of the processing apparatus may be reduced. The data output apparatus may include the second processing device. The second processing device may convert the display data to obtain the target data with a data amount smaller than the display data, and the target data may be displayed by the first display assembly and/or the second display assembly, thereby not only achieving targeted conversion processing of the display data but also further reducing the electrical power consumption of displaying the display data through the first display assembly and/or the second display assembly.

In the present disclosure, the drawings and descriptions of the embodiments are illustrative and not restrictive. The same drawing reference numerals identify the same structures throughout the description of the embodiments. In addition, figures may exaggerate the thickness of some layers, films, screens, areas, etc., for purposes of understanding and ease of description. It will also be understood that when an element such as a layer, film, area or substrate is referred to as being “on” another element, it may be directly on the another element or intervening elements may be present. In addition, “on” refers to positioning an element on or below another element, but does not essentially mean positioning on the upper side of another element according to the direction of gravity.

The orientation or positional relationship indicated by the terms “upper,” “lower,” “top,” “bottom,” “inner,” “outer,” etc. are based on the orientation or positional relationship shown in the drawings, and are only for the convenience of describing the present disclosure, rather than indicating or implying that the device or element referred to must have a specific orientation, be constructed and operated in a specific orientation, and therefore cannot be construed as a limitation of the present disclosure. When a component is described as being “connected” to another component, it may be directly connected to the other component or there may be an intermediate component present at the same time.

In this disclosure, relational terms such as “first” and “second” are only used to distinguish one entity or operation from another entity or operation, and do not necessarily require or imply that there is such actual relationship or sequence between these entities or operations them. Furthermore, the terms “comprises,” “includes,” or any other variation thereof are intended to cover a non-exclusive inclusion, such that an article or device including a list of elements includes not only those elements, but also other elements not expressly listed. Or it also includes elements inherent to the article or equipment. Without further limitation, an element associated with the phrase “comprises a . . . ” or “includes a . . . ” does not exclude the presence of other identical elements in an article or device that includes the above-mentioned element.

The units described above as separate components may or may not be physically separated. The components shown as units may or may not be physical units. They may be located in one place or distributed to multiple network units. Some or all of the units may be selected according to actual needs to achieve the purpose of the solution of the present disclosure.

Various embodiments have been described to illustrate the operation principles and exemplary embodiments. It should be understood by those skilled in the art that the present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. A data output apparatus comprising:
a first connection device, configured to be detachably connected to a second connection device of a processing apparatus to maintain a positional relationship between the data output apparatus and the processing apparatus;
a communication device, configured to receive display data sent by the processing apparatus; and
a display device configured to output the display data and including a first display assembly and a second display assembly.

2. The device according to claim 1, wherein:
the first display assembly is disposed at a first side of the data output apparatus, and the second display assembly is disposed at a second side of the data output apparatus, the first side being opposite to the second side.

3. The device according to claim 2, wherein:
the communication device and the first connection device are provided at a third side of the data output apparatus, an orientation of the third side being same as an orientation of the first side.

4. The device according to claim 1, wherein:
a display principle of the first display assembly is different from a display principle of the second display assembly.

5. The device according to claim 1, wherein:
the first display assembly includes a first display unit and a light-emitting unit, and light emitted by the light-emitting unit passes through the first display unit to output the display data; and
the second display assembly includes a second display unit, and the second display unit displays the display data by reflecting light of an environment where the data output apparatus is located.

6. The device according to claim 1, wherein:
the first communication device is configured to receive electrical power transmitted by the second connection device after the first connection device is connected to the second connection device.

7. The device according to claim 1, wherein:
the first connection device is configured to be magnetically connected to the second connection device.

8. A data output system comprising:
a data output apparatus including:
a first connection device;
a first communication device; and
a display device including a first display assembly and a second display assembly; and
a processing apparatus including a second connection device, a second communication device, and a processing device;
wherein:
the first connection device and the second connection device are configured to be detachably connected to each other to maintain a positional relationship between the data output apparatus and the processing apparatus;
the processing device is configured to generate display data;
the second communication device is configured to transmit the display data to the first communication device;
the first communication device is configured to receive display data; and
the display device is configured to output the display data.

9. The system according to claim 8, wherein:
the first display assembly is disposed at a first side of the data output apparatus, and the second display assembly is disposed at a second side of the data output apparatus, the first side being opposite to the second side.

10. The system according to claim 8, wherein:
the display device is a first display device;
the processing apparatus further includes a second display device;
when the first connection device is connected to the second connection device, an orientation of a display area of the first display assembly is consistent with an orientation of a display area of the second display device.

11. The system according to claim 8, wherein:
an electrical power consumption of the first display assembly when outputting the display data is larger than an electrical power consumption of the second display assembly when outputting the display data.

12. The system according to claim 8, wherein:
the processing apparatus further includes:
a first body and a second body connected to each other through a connection member, the first body and the second body being configured to change a relative positional relationship; and
an attitude determination device configured to determine the relative positional relationship; and
the processing device is further configured to control display of the display device through the second communication device based on the relative positional relationship.

13. The system according to claim 12, wherein:
the display device is a first display device; and
the processing apparatus further includes a second display device disposed at the first body.

14. The system according to claim 13, wherein:
the relative positional relationship includes that the second display device faces away from the second body, or the first body and the second body satisfy a coplanarity condition;
when the first connection device is connected to the second connection device, an orientation of a display area of the first display assembly is consistent with an orientation of a display area of the second display device; and
the processing device is further configured to control the first display assembly to display the display data through the second communication device.

15. The system according to claim 13, wherein:
the relative positional relationship includes that the second display device faces the second body;
when the first connection device is connected to the second connection device, an orientation of a display area of the second display assembly is opposite to an orientation of a display area of the second display device; and
the processing device is further configured to control the second display assembly to display the display data through the second communication device.

16. The system according to claim 13, wherein:
the processing apparatus is configured to be in:
a first mode, in which the second display device is in a display state, and the processing device transmits electrical power and the display data to the first display device through the second communication device based on a first transmission mode; or
a second mode, in which the second display device is in a non-display state, and the processing device transmits electrical power and the display data to the first display device through the second communication device based on a second transmission mode different from the first transmission mode; and
an electrical power consumption of the processing apparatus in the first mode is greater than an electrical power consumption of the processing apparatus in the second mode.

17. The system according to claim 16, wherein:
the second transmission mode includes that the processing device transmits the electrical power to the first display device through the second communication device in response to a status change of the display data, and transmits the display data after the status change to at least one of the first display assembly or the second display assembly.

18. The system according to claim 8, wherein:
the display device is a first display device;
the processing apparatus further includes a second display device configured to display the display data; and
an electrical power consumption of the second display device is greater than an electrical power consumption of the first display device.

19. The system according to claim 8, wherein:
the processing device is a first processing device;
the data output apparatus further includes a second processing device configured to perform conversion processing on the display data to obtain target data, a data amount of the target data being less than a data amount of the display data; and
at least one of the first display assembly or the second display assembly is configured to display the target data.

20. The system according to claim 8, wherein:
the first connection device is configured to be magnetically connected to the second connection device.
